(19) United States
(12) Patent Application Publication
(10) Pub. No.: US 2025/0163718 A1
(43) Pub. Date: May 22, 2025

(54) Water Spraying Tent

(71) Applicant: Lun Xu, Vancouver (CA)

(72) Inventor: Lun Xu, Vancouver (CA)

(21) Appl. No.: 18/515,676

(22) Filed: Nov. 21, 2023

(51) Int. Cl. E04H 15/02; B05B 9/03; E04H 15/42

(52) U.S. Cl. CPC E04H 15/02; B05B 9/03; E04H 15/42

(57) ABSTRACT

The present invention is directed toward a covered tent structure having a water channel incorporated into the body of the tent structure and configured to spray water into the interior of tent. The tent comprises a series of interconnected panels. The water channel preferably has a plurality of spouts for directing water into the interior of the tent. The tent is configured to be collapsible for easy storage and transportation.

### FIELD OF THE INVENTION

The invention is directed toward an outdoor water tent. More specifically, the invention is directed to a tent structure that contains a water channel having multiple spouts for the distribution of water into the interior of the tent and/or the exterior of the tent.

### BACKGROUND OF INVENTION

Backpacking and camping are active recreational activities. They present the opportunity for individuals to engage with nature. To obtain protection from the elements, individuals may utilize tents or campers. Campers are more permanent structures and can have plumbing included while tents primarily are temporary structures and do not include plumbing.

Tent camping can be fine but individuals often do not have a means for bathing. What is needed is a tent structure that is collapsible, easy to transport, and provides a means for a user to bath while tent camping or hiking.

### SUMMARY OF THE INVENTION

In accordance with the present invention, there is provided with one embodiment, an outdoor water tent structure. The water tent structure comprises a plurality of supports. The plurality of supports contain water channel support panels and support an exterior membrane structure. The water channel support panels contain multiple spouts, that when pressurized, spray the water in the interior direction of the enclosed structure. The preferred embodiment has a hose attached to multiple panels that spray water towards an inner structure.

The invention is directed toward a water spray tent structure comprising a plurality of panels, wherein said plurality of panels define an enclosed area; a water channel secured to at least one of said plurality of panels; a water source receiving adapter connected to said water channel; one or more spouts disposed in said water channel; and wherein said one or more spouts are configured to spray water into said enclosed area.

The water spray tent structure may further comprise a control valve connected to said water channel. The water channel may further comprise a reservoir. In another embodiment there is a separate reservoir connected to said water channel.

In another embodiment at least one of said plurality of panels comprises a mesh portion. The water spray tent structure may further comprise a doorway disposed in one of said plurality of panels. The doorway may comprise a flap and one or more ties for securing said flap. In another embodiment the doorway may comprise a flap and a zipper connected to said flap.

In another embodiment the water spray tent structure may further comprise one or more support poles. The support poles may be external to the panels. In other embodiments each support pole is integral to a respective panel. In another embodiment the water spray tent structure may further comprise a storage pocket. The water spray tent structure may further comprise an outer cover removably secured to said water spray tent structure.

The water spray tent structure may further comprise a floor. The floor may have one or more drain openings. The water spray tent structure may further comprise one or more stakes for securing said water spray tent structure to the ground. In another embodiment said one or more spouts are disposed directly above said enclosed area. In another embodiment said one or more spouts are disposed lateral to said enclosed area.

In another embodiment the invention is directed toward a water spray tent structure comprising a plurality of panels, wherein said plurality of panels define an enclosed area; a water channel secured to at least one of said plurality of panels; a water source receiving adapter connected to said water channel; a reservoir connected to said water channel, wherein said reservoir is disposed directly above said enclosed area; one or more spouts disposed in said reservoir; and wherein said one or more spouts are configured to spray water into said enclosed area.

The water spray tent structure may further comprise a control valve connected to said water channel. The water spray tent structure may further comprise a plurality of flexible support poles; wherein each of said plurality of flexible support poles are respectively integral to one of said plurality of panels; wherein said plurality of flexible support poles are configured to be positioned between an erect configuration and a folded configuration; wherein in said erect configuration said enclosed area is at a maximum volume; and wherein in said folded configuration said folded configuration, said enclosed area has a volume that is less than said maximum volume.

In other aspects of this embodiment, the means for coupling the water source to a water channel support panel is done with a water inlet. The water inlet may comprise of an on/off lever or valve or an adjustable nozzle to regulate pressure. If additional pressure is necessary, a high-pressure pump may be necessary to increase the flow of water through the water channel support panels. An element of constriction may also be present within the structure of the water support panels to increase pressure where necessary.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a perspective view of an outer tent structure in accordance with an embodiment of the present invention;

FIG. 2 is a perspective view of a tent structure where the path of water dispersion is shown flowing inward in accordance with an embodiment of the present invention;

FIG. 3 is an enhanced view of two individual panels illustrating the water carrying channels and water dispersion in accordance with an embodiment of the present invention;

FIG. 4 is a closer view of the water delivery system and its main inlet connection, water flow, and spouts within the channel in accordance with an embodiment of the present invention;

FIG. 5 is a side cutaway view of an embodiment of the present invention;

FIG. 6 is a perspective view of another embodiment of the tent structure;

FIG. 7 is a perspective view of another embodiment of the tent structure;

FIG. 8 is a perspective view of another embodiment of the tent structure; and

FIG. 9 is a perspective view of another embodiment of the tent structure.

### DETAILED DESCRIPTION OF THE PREFERRED EMBODIMENT

Although the invention can take on various forms, the preferred embodiments of the present invention are depicted in the illustrations and will be thoroughly explained in the following sections.

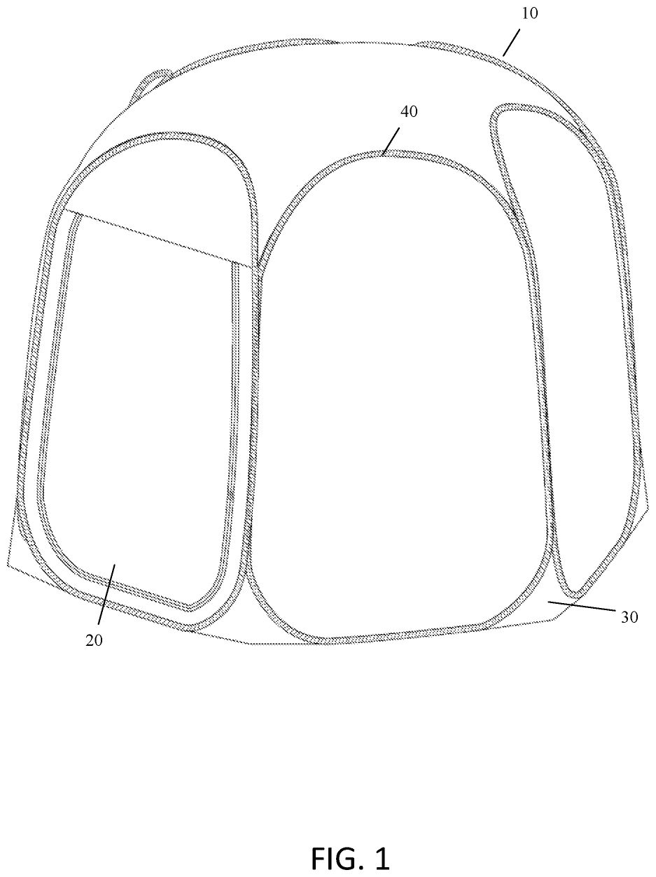

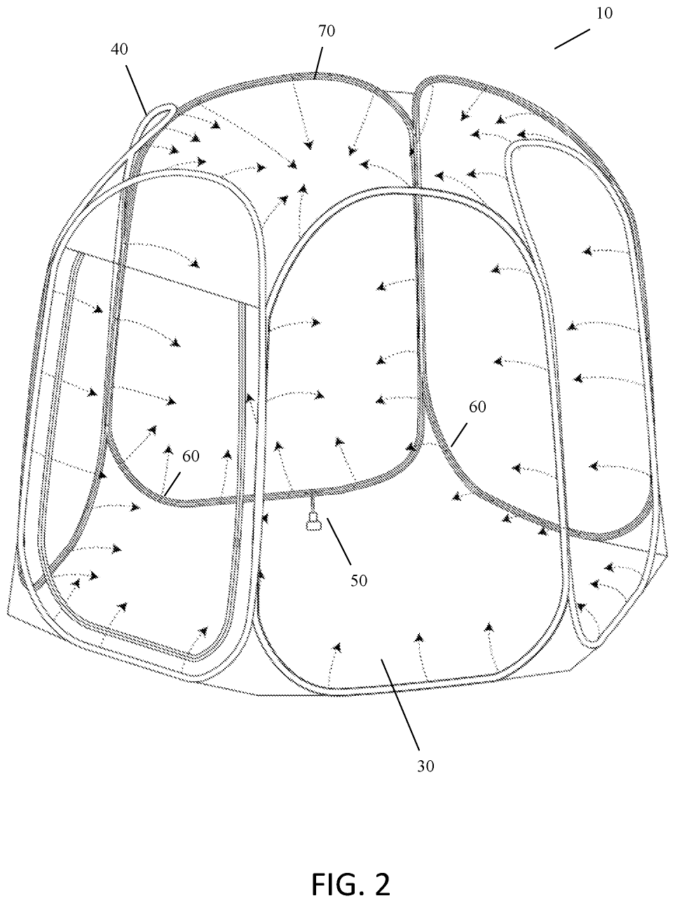

Referring to FIG. 1 and FIG. 2, an embodiment of the water spray tent 10 is illustrated. Varying materials may be used for the tent panels 12 and water spray tent 10 for providing shelter. The support frame 40 may be made of steel, aluminum, fiber glass, or another sturdy, lightweight material. In other embodiments the support frame 40 is made of spring steel that is configured to stretch the material of the panel 12. The water spray tent 10 may be made entirely from nylon or another synthetic material or have an open mesh to allow for the flow of air, or a combination of both. In addition, a structure of fabric protecting the tent from the outside elements, such as a rainfly, may be included. The entry door 20 may be self-latching, self-closing, or secured using a zipper. The entry door 20 provides a means for passing into the interior of the water spray tent 10.

Also referring to FIG. 1 is a structure floor 30 that may be open, with no floor, to allow natural draining or present with a draining system. The draining system may include small holes with varying diameters or raised channels to divert the water from collecting. The structure floor 30 may also be constructed from a waterproof, synthetic material to prevent the water from pooling, or in combination, have a built-in drain where the water is channeled outside of the tent. Lastly, the structure floor 30 may intentionally be designed to allow for the collection of water.

Now referring to FIG. 2 is an illustrated depiction of the hose 70 and water distribution. The spouts 60 may be separated by predetermined distance or predesigned based on manufacturing constraints. Additional support may be required on the water hose 70 depending on the necessary water pressure needed to distribute flow from multiple spouts 60. Additional support rods or poles may be necessary. In the embodiment illustrated the hose 70 is attached directly to the support frame 40. The hose 70 may be self-adhered to the support frame 40 through heat bonding, glue, nylon stitching or another form of material, or in combination. In other embodiments the hose 70 is removably secured to the support frame 40. The hose 70 and support frame 40 could also be attached by metal or plastic clips to connect the components together.

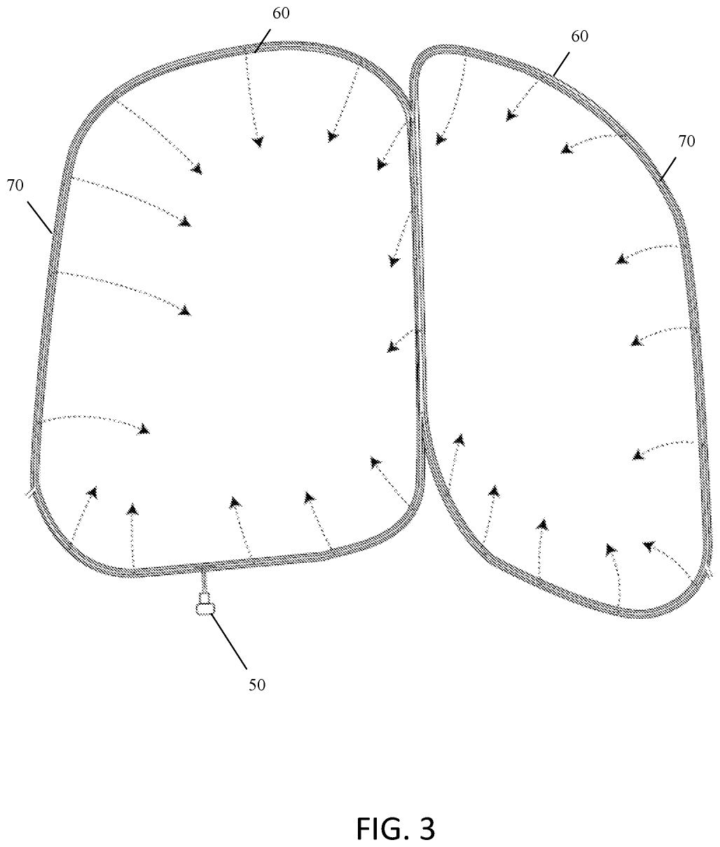

Referring now to FIG. 3 is a 2-panel tent structure diagram depicting the likely location of the water inlet 50. This location will possibly be the third panel west of the front enclosure at the base of the structure. In the preferred embodiment the hose 70 is distributed across multiple panels 12. The hose 70 may be a singular tube traversing the panels 12 or may form “Y” junctions with other portions of the hose 70 on other panels 12. This union allows the water or other liquid to flow freely throughout the entirety of the multiple panels 12. The hose 70 may also be designed to attach individually to each individual panel 12, requiring each hose 70 to have its own water inlet 50.

Also referring to FIG. 3 the hose 70 may be constructed of nylon, vinyl, polyurethane, polyethylene, PVC, or synthetic or natural rubbers and may or not be expandable and collapsible. The length, diameter, and shape of the hose 70 may vary to maximize optimal pressure necessary to distribute water through its channel, given that typical residential, commercial, and campground water sources generate between 40-60 psi on average.

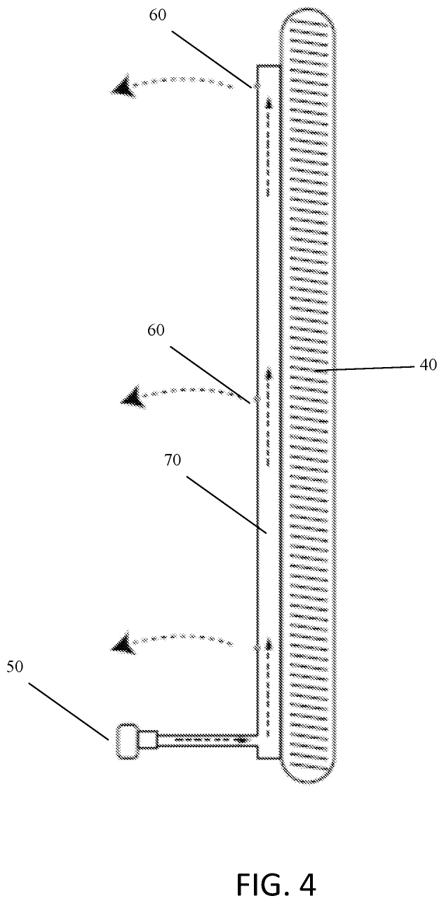

Now referring to FIG. 4 is an enhanced illustration of the hose 70, the water inlet 50, and the spouts 60. The spouts 60 may be any size and shape. The spouts 60 may be punched holes in the hose 70 material or may be individual nozzles of any shape or size formed either straight or at an angle. The spouts 60 may have a certain nozzle type that produces either a flat fan shape, hollow cone shape, full cone shape, solid stream shape, or a variety of other pressurized shapes. Varying the size and/or shape of the spouts will create different spray patterns.

Also referring to FIG. 4, the water inlet 50 may be any size or shape. The water inlet 50 may be retrofitted to support several other possible liquid materials or is simply fitted with a common ¾″ garden hose connection. The water inlet 50 may also have a separate adjustable coupled fitting that is used to close, open, or regulate water pressure. A high-pressure pump may be added to support increased hydraulic water pressure.

The water hose 70 may be any size and shape and used in any configuration. There may be additional components utilized with the water line to permit control and manipulation of the water without diverting from the scope of the invention. For instance the water line may have one or more control valves (not shown). The control valves may be used to completely shut off the water source from the hose 70 or may be used between portions of the hose 70 to permit water to only come out of desired spouts 60. The water inlet 50 may be connected to a direct water source or may be connected to a portable water tank. The portable water tank may supply water by gravity, such as hanging a source back from an upper tree limb, or may have a small pump to pump water from a natural water source such as a stream.

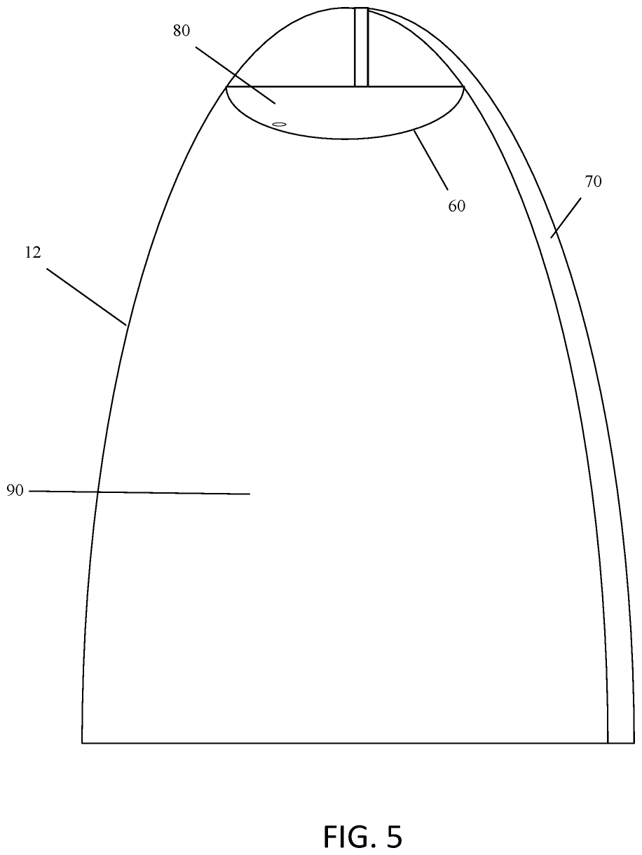

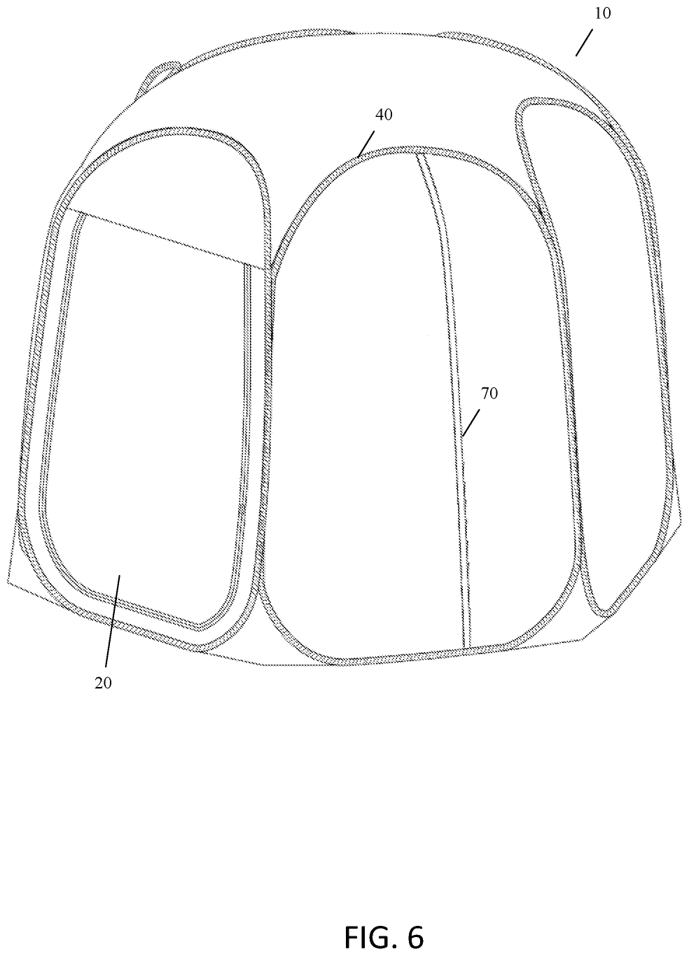

Referring to FIG. 5 and FIG. 6, another embodiment of the water spray tent 10 is illustrated. In this embodiment, the hose 70 is not connected to the support frame 40 but is instead connected to the panel 12. In this embodiment there may be a single hose 70 on one panel 12 or connected to multiple panels 12. As show in FIG. 5, the hose 70 carries water to the top of the water spray tent 10 and the hose terminates in a reservoir 80. The reservoir 80 may be any size and shape. The reservoir 80 may be a holding tank to hold a predetermined amount of water. In other embodiments the reservoir 80 is simply a folding of the hose 70 into two or more parallel rows without any additional storage space. In the illustrated embodiment the reservoir 80 contains a plurality of spouts 60 for releasing water into the enclosed area 90 defined by the panels 12.

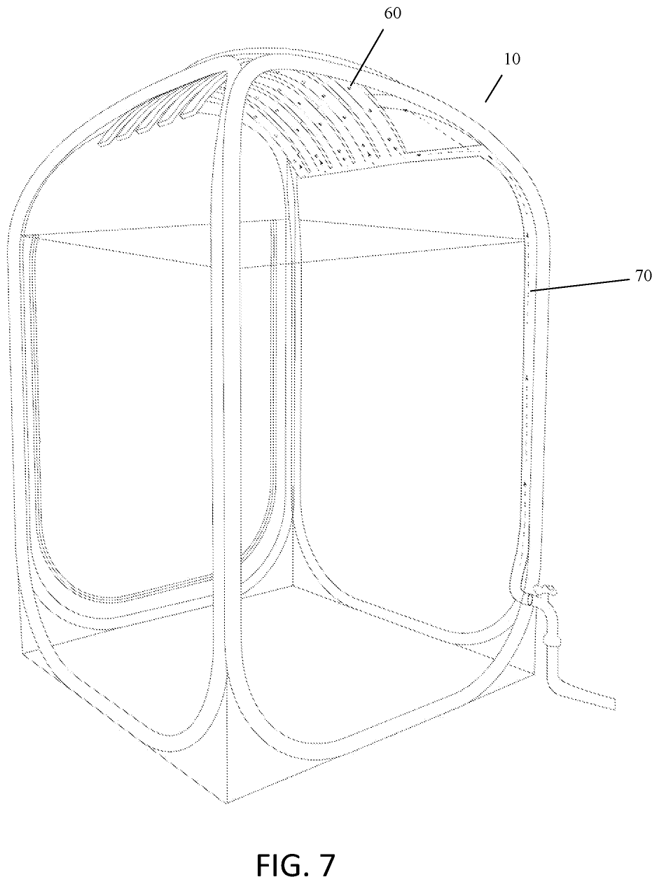

Referring to FIG. 7, another embodiment of the water spray tent 10 is illustrated. In this embodiment the hose 70 extends vertically along the body of the water spray tent 10. When the hose 70 reaches the top of the internal section of the water spray tent 10, the hose 70 splits into a plurality of hose portions. Each portion of the hose contains a plurality of spouts 60. The water sprays from the spouts 60 downward into the interior of the water spray tent 10.

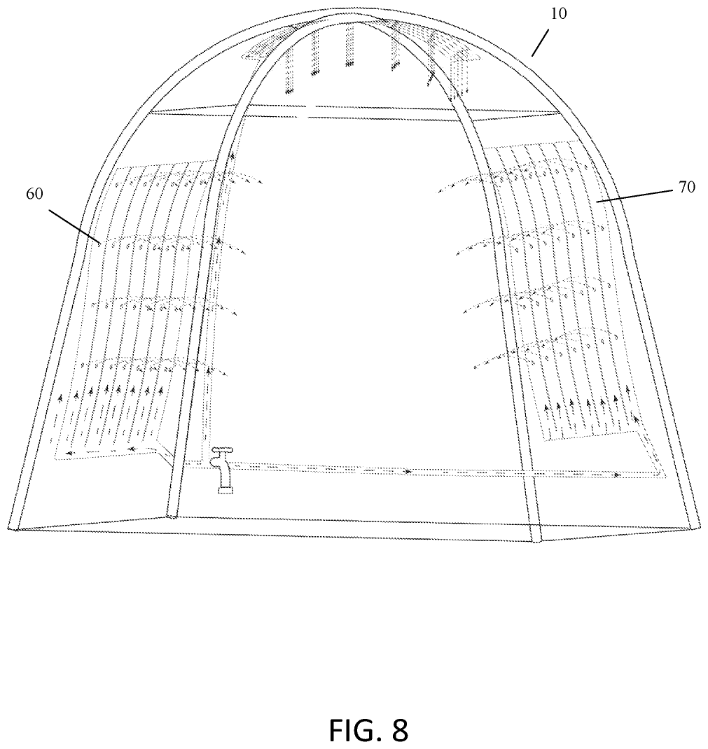

Referring to FIG. 8, another embodiment of the water spray tent 10 is illustrated. In this embodiment the hose 70 splits into a plurality of hose portions that are embedded in the panels 12 of the water spray tent 10. These plurality of hose portions in the panels 12 each have a plurality of spouts 60 to spray water into the interior of the water spray tent 10. This embodiment may or may not have a section of hose portions in the top portion of the tent to spray water downward.

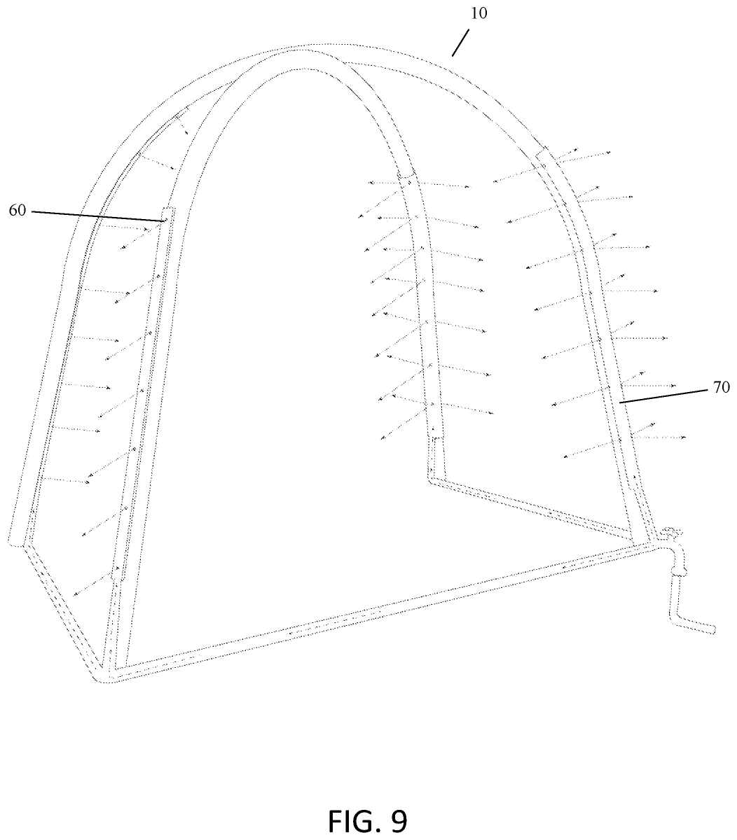

Referring to FIG. 9, another embodiment of the water spray tent 10 is illustrated. In this embodiment the hose 70 may have portions that are disposed in the interior of the water spray tent 10 or disposed on the exterior of the water spray tent 10, or both. The hose 70 may be configured so that the spouts 60 spray water into the interior of the water spray tent 10, spray water outside of the water spray tent 10, or both.

In other embodiments the hose 70 has sufficient hydrostatic pressure to keep the water spray tent 10 in an erect configuration without the need to utilize a support frame 40.

In some embodiments there may be a panel 12 disposed at any position of the water spray tent 10, including the side or top. In other embodiments the hose 70 may be modular so that section can be removed or included in portions of the water spray tent 10 as desired. For instance, a user may choose to have a portion of the hose 70 on a panel 12 and the interior roof of the water spray tent 10. Another user may desire to utilize two portions of the hose 70 on two panels 12 but remove the section that is on the interior roof. Another user may choose to utilize the hose 70 on the support frame 40. In these separate configurations a user may connect or disconnect portions of the hose through one or more male/female connection points. When a section of the hose 70 is removed, the end of the hose 70 that remains connected to the water spray tent 10 may be plugged to prevent water from spraying out, or may be replaced by an end cap having a water feature or a spout 60.

In other embodiments of the invention the water spray tent 10 may be self-erecting. In the embodiment the difference is primarily in the support frame 40. The support frame 40 may be comprised of different sections of poles that users put together and then attach to the panels 12. However, in the self-erecting embodiment the support frame 40 is formed from a flexible plastic or metal rod that is integral to each panel 12. The user can bend the rod of each panel 12 to fold the panels 12 to a smaller size. In other embodiments the support frame 40 is completely removed from the panels 12 and the panels 12 may be rolled up to a small size and stored in a bag.

In other embodiments other there may be additional components added to the water spray tent without diverting from the scope of the invention, such as a LED lighting powered by a small solar panel, alkaline or lithium batteries. In other embodiments there may be an external reservoir connected to the water source which allows sunlight to pass through and heat the water. In other embodiments there may be an electric or gas water heater connected to the hose 70 to heat the water. In other embodiments a user may heat water in a pot over a fire and store the heated water in a holding tank that is connected to the water inlet 50.

The water spray tent 10 may be utilized in any tent configuration. For instance, the water spray tent 10 may be a flexible frame tent, a pop-up tent, large tents, small tents, tents for kids, tents for pets, or any other types of tents.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

The invention claimed is:

1. A water spray tent structure comprising:
a) a plurality of panels, wherein said plurality of panels define an enclosed area;
b) a water channel secured to at least one of said plurality of panels;
c) a water source receiving adapter connected to said water channel;
d) one or more spouts disposed in said water channel; and
e) wherein said one or more spouts are configured to spray water into said enclosed area.

2. The water spray tent structure as in claim 1 further comprising a control valve connected to said water channel.

3. The water spray tent structure as in claim 1 wherein said water channel further comprises a reservoir.

4. The water spray tent structure as in claim 1 further comprising a reservoir connected to said water channel.

5. The water spray tent structure as in claim 1 wherein at least one of said plurality of panels comprises a mesh portion.

6. The water spray tent structure as in claim 1 further comprising a doorway disposed in one of said plurality of panels.

7. The water spray tent structure as in claim 6 wherein said doorway further comprises a flap and one or more ties for securing said flap.

8. The water spray tent structure as in claim 6 wherein said doorway further comprises a flap and a zipper connected to said flap.

9. The water spray tent structure as in claim 1 further comprising one or more support poles.

10. The water spray tent structure as in claim 9 wherein each of said one or more support poles are integral to a respective panel.

11. The water spray tent structure as in claim 1 further comprising a storage pocket.

12. The water spray tent structure as in claim 1 further comprising an outer cover removably secured to said water spray tent structure.

13. The water spray tent structure as in claim 1 further comprising a floor.

14. The water spray tent structure as in claim 13 further comprising one or more drain openings in said floor.

15. The water spray tent structure as in claim 1 further comprising one or more stakes for securing said water spray tent structure to the ground.

16. The water spray tent structure as in claim 1 wherein said one or more spouts are disposed directly above said enclosed area.

17. The water spray tent structure as in claim 1 wherein said one or more spouts are disposed lateral to said enclosed area.

18. A water spray tent structure comprising:
a) a plurality of panels, wherein said plurality of panels define an enclosed area;
b) a water channel secured to at least one of said plurality of panels;
c) a water source receiving adapter connected to said water channel;
d) a reservoir connected to said water channel, wherein said reservoir is disposed directly above said enclosed area;
e) one or more spouts disposed in said reservoir; and
f) wherein said one or more spouts are configured to spray water into said enclosed area.

19. The water spray tent structure as in claim 18 further comprising a control valve connected to said water channel.

20. The water spray tent structure as in claim 18 further comprising
a) a plurality of flexible support poles;
b) wherein each of said plurality of flexible support poles are respectively integral to one of said plurality of panels;
c) wherein said plurality of flexible support poles are configured to be positioned between an erect configuration and a folded configuration;
d) wherein in said erect configuration said enclosed area is at a maximum volume; and
e) wherein in said folded configuration said folded configuration, said enclosed area has a volume that is less than said maximum volume.
